(19) United States
(12) Patent Application Publication
(10) Pub. No.: US 2019/0322135 A1
(43) Pub. Date: Oct. 24, 2019

(54) LIGHTWEIGHT AXLE

(71) Applicant: Amsted Rail Company, Inc., Chicago, IL (US)

(72) Inventors: Jason Taylor, Granite City, IL (US); Kevin Young, Paragould, AR (US)

(21) Appl. No.: 15/958,070

(22) Filed: Apr. 20, 2018

(51) Int. Cl. B60B 37/08; B60B 17/00

(52) U.S. Cl. CPC B60B 37/08; B60B 35/08; B60B 17/0013

(57) ABSTRACT

An improved railway car axle has a generally hollow cylindrical elongated body. The axle includes a journal near either end adapted to receive a bearing, and a dust guard adjacent the journals. A wheel seat is adjacent the dust guard and is adapted to receive a railway wheel thereon. The axial center interior portion of the railway axle is generally hollow. The railway axle is comprised of a steel with specified alloy range, mechanical properties and is of specified internal and external dimensions to allow the axle to be formed in a forging operation and to be utilized in heavy haul railway freight car service.

### TECHNICAL FIELD

This application relates to axles for railway cars. More specifically, this application relates to railway car axles having a hollow interior portion.

### BACKGROUND

Railway cars, and particularly railway freight cars, often utilize a freight car truck that includes two side frames supporting a transverse bolster on spring groups. Each side frame includes a pedestal jaw adapted to receive an end of the railway car axle itself. A bearing and bearing adapter are utilized between the axle and the pedestal jaw. A railway wheel is mounted laterally inwardly from the side frame pedestal area on the wheel seat area of the axle. Two wheels are mounted on each axle.

The Association of American Railroads (AAR) sets forth standards for heavy haul service freight car trucks such that they are sized and adapted to be utilized with railway freight cars having a gross weight loading of up to 286,000 pounds or more. For such gross rail load, axles serve an important function on the trucks to assure the appropriate performance of the railway freight car and ability to handle the desired freight loading. Axles in such service today are comprised of solid steel, elongated structures having a generally cylindrical outer surface.

The rails and related infrastructure for railroads limit a railcar's gross rail load and speed and, therefore, the mass rate at which products are transported. To increase the mass rate at which products are transported, either the weight of a railcar must be reduced or the speed at which the railcar travels must be raised.

### SUMMARY

This application describes examples of a railway car axle. In one example, the axle forms an elongated cylindrical body. The axle includes a central section and a pair of journal sections positioned on opposite sides of the central section. The axle may also include two wheel seat sections, each wheel seat section positioned between each of the journal sections and the central section adjacent the central section, and two dust guard sections, each dust guard section positioned between a wheel seat section and a journal section. The axle is hollow, or at least comprises a hollow interior portion. In some instances, the axle is forged into a seamless tube.

In one example, the center section has a minimum wall thickness of about 1.09 inches, wherein the wheel seat sections have a minimum wall thickness of about 1.33 inches, the dust guard sections have a minimum wall thickness of about 1.86 inches, and the journal sections have a minimum wall thickness of about 1.84 inches. The hollow interior portion has a diameter of at least about 6 inches in at least one location within the central section, wherein the hollow interior portion has a diameter of at least about 6 inches in at least one location within each wheel seat section, wherein the hollow interior portion has a diameter of at least about 3.8 inches in at least one location within each dust guard section, and wherein the hollow interior portion has a diameter of at least about 2.5 inches in at least one location within each journal section. The axle and/or the elongated cylindrical body has a minimum ultimate tensile strength of about 136 ksi, a minimum yield strength of about 96 ksi, a minimum elongation of about 16 percent, a minimum reduction of area of about 35 percent, a grain size of about 6-9 per ASTM E112, and a minimum rotating beam test sample endurance limit (Se′) of about 68 ksi.

The axle and/or the elongated body is formed from an alloy that includes about 0.43-0.75 percent by weight carbon, about 0.6-2.2 percent by weight manganese, about 0.0-0.045 percent by weight phosphorus, about 0.01-0.03 percent by weight sulfur, about 0.15-0.7 percent by weight silicon, about 0.02-0.1 percent by weight vanadium, about 0.0-0.1 percent by weight niobium, about 0.0-2 ppm hydrogen, about 0.0-0.3 percent by weight nickel, about 0.0-0.2 percent by weight chromium, about 0.0-0.15 percent by weight molybdenum, about 0.0-0.25 percent by weight copper, and about 0.01-0.02 percent by weight aluminum, with the remainder being essentially iron.

In another example, the center section has a minimum wall thickness of about 0.94 inches, wherein the wheel seat sections have a minimum wall thickness of about 1.30 inches, the dust guard sections have a minimum wall thickness of about 1.625 inches, and the journal sections have a minimum wall thickness of about 1.625 inches. the hollow interior portion has a diameter of at least about 6 inches in at least one location within the central section, wherein the hollow interior portion has a diameter of at least about 6 inches in at least one location within each wheel seat section, wherein the hollow interior portion has a diameter of at least about 3.8 inches in at least one location within each dust guard section, and wherein the hollow interior portion has a diameter of at least about 2.5 inches in at least one location within each journal section. The axle and/or the elongated cylindrical body has a minimum ultimate tensile strength of 152 ksi, a minimum yield strength of 132 ksi, a minimum elongation of 16 percent, a minimum reduction of area of 42 percent, a grain size of about to 6-9 per ASTM E112, a minimum Rockwell C hardness of Rc 30, and a minimum rotating beam test sample endurance limit (Se′) of about 76 ksi. The axle and/or the elongated body is formed from an alloy that includes about 0.38-0.43 percent by weight carbon, about 0.75-1.0 percent by weight manganese, about 0.0-0.015 percent by weight phosphorus, about 0.0-0.005 percent by weight sulfur, about 0.2-0.35 percent by weight silicon, about 0.02-0.03 percent by weight vanadium, about 0.1-0.25 percent by weight nickel, about 0.8-1.1 percent by weight chromium, about 0.15-0.25 percent by weight molybdenum, about 0.0-0.25 percent by weight copper, about 0.0-0.002 percent by weight lead, about 0.0-0.03 percent by weight titanium, and about 0.015-0.055 percent by weight aluminum, and the remainder essentially iron.

In some examples, the hollow interior portion of the axle comprises a journal bore, wherein the nominal diameter of the journal bore maintains a cross section large enough to limit journal deflection due to shear and bending to provide an acceptable level of fatigue due to frettage corrosion and yield an acceptable fretting index. The tolerance position of the axle journal bore maintains sufficient threaded hole wall thickness to achieve full thread strength for securing bearing houses to axle journals thereby minimizing the probability for bearings to loosen during service.

This application also describes examples of methods for forming a railway car truck axle. The methods involve forging a metallic material into a seamless tube having an elongated cylindrical body with a hollow interior portion. For example, the methods can involve forming the axles described above, including forging a metallic material into a seamless tube that includes forming a central section, forming a pair of journal sections positioned on opposite sides of the central section, forming two wheel seat sections each section positioned on each end of the central section, and forming two dust guard sections, each dust guard section positioned between a wheel seat section and a journal section. The formed axle can include the alloys, the material properties, and/or the physical dimensions described in any of the examples above.

### BRIEF DESCRIPTION OF THE DRAWINGS

FIG. 1 is a perspective view of a railway car truck utilizing a railway axle in accordance with examples described in this application.

FIG. 2 a side view of a railway car axle in accordance with examples described in this application.

FIG. 3 is a detailed partial side cross sectional view of a railway car axle in accordance with examples described in this application.

FIG. 4 is a side view of a railway car axle in accordance with examples described in this application.

FIG. 5 is a detailed partial side cross sectional view of a railway car axle in accordance with examples described in this application.

FIG. 6 is a side view of a railway car axle in accordance with examples described in this application.

FIG. 7 is a detailed partial side cross sectional view of a railway car axle in accordance with examples described in this application.

### DETAILED DESCRIPTION

This application describes examples of axles, in particular, axles for railway car trucks. The axles described herein have various configurations and designs that reduce the weight of the axle without sacrificing, and even making improvements in performance. For instance, many embodiments described herein describe configurations of an axle with a bore or other hollow interior portions that reduce the material, and thereby the weight, of the axle. The unique designs, shapes, selection of materials, and other configurations of the various axles described herein allow for a railcar axle to perform in a manner as reliable as, or even better than existing axles, while appreciating a significant reduction in material and weight.

The manufacture and structure of the described railway axles utilize the following approaches in order to reduce an axle's weight while maintaining an acceptable Modified Goodman fatigue safety factor.

1. Simplification of the manufacturing process.

2. Use of alloyed steels with chemical compositions and associated mechanical properties that yield acceptable fatigue endurance limits.

3. Optimization of axle structure and geometry to reduce stresses in critical areas of the axle while maintaining the form, fit, and function of industry standard axles.

4. Manufacture of stronger axles by analyzing assembled wheelsets subjected to heavy haul loads including stresses induced during axle manufacturing processes and residual stresses induced during wheelset assembly and employing manufacturing methods to address key issues including fatigue from bearing and wheel frettage corrosion as well as internal surface finish characteristics.

5. Identification of performance gains mainly in the area of increased lading capacity for railway freight cars.

The manufacturing process of the axle structures presented herein are simplified by starting with seamless steel tube and then forging the axles. In addition, forging the axle from seamless tube reduces waste material, allows for a greater weight reduction and minimizes the cost of manufacturing an axle over other standard practices, including boring the axle with a constant inside diameter.

The axle structures presented herein may utilize either of the two grades of steel, Amsted Rail Grade 1 and Amsted Rail Grade 2, with chemical compositions and mechanical properties for each listed in Tables 1 and 2, respectively, as set forth below. The chemical compositions of both of these alloyed steels provide improved mechanical properties including higher yield strengths, ultimate tensile strengths, and increased reduction of area while maintaining the minimum elongation of steels presented in prior art. The increased ultimate tensile strengths for these two grades of steels results in higher fatigue strengths.

Rotating beam fatigue tests are conducted to quantitatively determine the increase in fatigue strength by measuring a variable used to determine the Modified Goodman fatigue safety factor known as the rotary-beam test specimen endurance limit (Sₑ′). The rotary-beam test specimen endurance limit (Sₑ′) is used in conjunction with the surface condition modification factor (kₐ), the size modification factor (k_{b}), the load modification factor (k_{c}), the temperature modification factor (k_{d}), the reliability factor (kₑ), and various miscellaneous effects factors (k_{fi} . . . k_{fj}) to determine the endurance limits (Sₑ) at critical locations of the axle given the geometry and condition of use. Hence, the rotary-beam test specimen endurance limit (Sₑ′), which, when combined with certain manufacturing techniques such as peening, shot peening, nitriding, gas nitriding, plasma nitriding, machining, or grinding set forth herein, provide significant improvements to the endurance limits (Sₑ) at critical locations of the axle. The endurance limits (Sₑ) at critical locations in lightweight axles presented herein (which include stresses associated with assembling wheelsets discussed below) achieve acceptable Modified Goodman fatigue safety factors.

The axle structures presented herein have been reviewed using advanced analytical techniques such as finite element analysis, FEA. With FEA, axle geometry was optimized by lowering stresses in critical areas of the axle while maintaining the form, fit, and function of industry standard axles. This optimization greatly reduced the weight of the axle leading to substantial performance gains.

Mounting wheels on lightweight axles induces stresses in the axle that must be considered when determining the endurance limits required to manufacture acceptable lightweight axles. Furthermore, advanced loading techniques available in FEA programs were utilized that more accurately represent loading in revenue service. The advanced techniques include the use of parabolic bearing loads applied to each axle bearing cone and wheel hub as well as interference fits between axle bearing cones and axle journals and wheel hubs and axle wheel seats.

The axle designs presented herein reduce fatigue from bearing frettage corrosion to an acceptable level. When a rotating axle deflects under load, microscopic motions of tightly fitted parts, such as the components in a bearing and the bearing components press-fit onto an axle, produce frettage corrosion, also known as fretting wear, which involves surface discoloration, pitting, and eventually fatigue. Over time, frettage corrosion reduces the clamp forces between the axle and the bearing components press-fit onto an axle. Frettage corrosion cannot be calculated, however, frettage corrosion is known to increase with increased axle journal deflection and reduced axle journal hardness.

The axle designs presented herein utilize one or both of the following techniques to reduce fatigue due to bearing frettage corrosion: (1) limiting journal deflection due to shear and bending by controlling the position while limiting the diameter of the bore through the journal, and (2) increasing the surface hardness or inducing compressive stresses on axle surfaces between press-fit components.

The journal bore diameter and position, including manufacturing tolerances, of the axle designs presented herein limit microscopic motions that are known to cause bearing frettage corrosion by limiting journal deflection due to shear and bending and, therefore, assist in maintaining an acceptable bearing fretting index. AAR derived the fretting index for solid axles to provide a simplistic correlation between axle journal deflection and frettage corrosion. Per AAR M-934 Rule 4.3, the fretting index is based on analyzing axle deflection due to shear and bending from the outboard edge of the axle dust guard to the end of the axle journal. The reference deflection is that of a standard, solid Class F axle which is approximately 6.39E−04 inches. The fretting index of any axle can be calculated by dividing the deflection of that axle by that of the reference Class F axle, hence, the fretting index is a number between 0 and 1. Numbers less than 1 indicate less microscopic motion than the reference Class F axle, and therefore, less frettage corrosion, which lessens fatigue due to frettage corrosion. Analyses show the geometry and structure of the axle designs presented herein maintain a fretting index of approximately 0.57.

Another method in which the axle designs presented herein can help decrease frettage corrosion is by increasing the surface hardness or inducing compressive stresses on axle surfaces between press-fit components. Amsted Rail Grade 2 maintains a minimum Rockwell C hardness of 30, which is substantially harder than AAR Grade F steel. Manufacturing processes such as burnishing, rolling, roller burnishing and low plasticity burnishing induce compressive stresses on axle surfaces between press-fit components. These processes are discussed in greater detail throughout this patent.

Additionally, the tolerance position and 2.5″ nominal diameter of the axle journal bore maintains a cross section and enough threaded hole wall thickness to achieve full thread strength. Bolts secure bearing houses to axle journals using the threaded holes in the end of the axle; hence, the designs presented herein maintain complete fastener strength thereby reducing the likelihood of thread failure minimizing the probability for bearings to loosen during service.

Fatigue due to wheel frettage corrosion is addressed in a similar manner as fatigue due to bearing frettage corrosion; however, additional consideration is required due to the increased interference press-fit needed to achieve sufficient contact pressure between the wheel hub and axle wheel seat. The increased interference between the outside diameter of the axle wheel seat and the diameter of the wheel bore induces residual compressive stresses on the external surfaces of the axle wheel seat and tensile stresses on the internal surfaces directly underneath the axle wheel seat. The tensile stresses induced on the internal surfaces directly beneath the axle wheel seat and surrounding areas are substantial and must be taken into consideration when evaluating internal surface characteristics and their effects on the fatigue endurance limit of axles.

Manufacturing processes such as peening (examples include but are not limited to shot peening or laser peening), burnishing (examples include but are not limited to roller burnishing or low plasticity burnishing), or any other process that creates residual compressive stresses may be used to counteract the residual tensile stresses on the internal surfaces of hollow axles. Residual compressive stresses help counteract the formation and propagation of cracks in and along internal and external surfaces. These processes may be performed before or after the wheelset is mounted on the axle. Other manufacturing processes such as gas nitriding, machining, grinding, honing, and wire brushing may be utilized to counteract unwanted internal and external surface characteristics.

The influence of the aforementioned design considerations on the strength of wheelsets was ascertained using rotating beam fatigue analyses in conjunction with the Modified Goodman approach as the criteria for failure. In particular, fully reversible alternating stresses and midrange stresses obtained from FEAs were utilized in the Modified Goodman approach to determine the ultimate tensile strength and endurance limit required to produce a lightweight axle with adequate strength while maintaining the necessary form, fit, and function of standard axles.

The axle designs presented herein have weight reductions ranging from about 34% to about 44% for Amsted Rail Grade 1 and Amsted Rail Grade 2, respectively, from equivalent duty solid axles effectively reducing the weight of axles from about 1124 lbs. to about 742 lbs. or about 629 lbs. for Amsted Rail Grade 1 and Amsted Rail Grade 2, respectively, depending on the final axle configuration. The maximum reduction in axle mass allows for nearly one ton of additional lading to be transported in each railcar for each loaded car trip. The reduction in axle weight equals about 168,000 lbs. to about 218,000 lbs. per 110-car unit train for Amsted Rail Grade 1 and Amsted Rail Grade 2, respectively. The decrease in axle weight also increases locomotive fuel economy during empty car conditions. In addition, maintaining the form, fit, and function allows interchangeability of axles of the structure described herein with existing axles as well as the use of industry standard wheels, bearings, wheelset presses, etc., negating the need for additional expenditures to use the axle designs presented herein.

The two grades of alloyed steels proposed for the axle designs presented herein have chemical compositions and mechanical properties as shown in Table 1 and Table 2, respectively. Accordingly, the Modified Goodman fatigue safety factor of lightweight axles in accordance with the described structures, including stresses induced during wheelset assembly, are acceptable for heavy haul railway freight car service.

TABLE 1
Chemical Composition for Lightweight Axles
Chemical Composition

| | Amsted Rail-Grade 1 | | Amsted Rail-Grade 2 | |
|---|---|---|---|---|
| Element | Min (%) | Max (%) | Min (%) | Max (%) |
| Carbon | 0.43 | 0.75 | 0.38 | 0.43 |
| Manganese | 0.6 | 2.2 | 0.75 | 1 |
| Phosphorus | — | 0.045 | — | 0.015 |
| Sulfur | 0.01 | 0.03 | — | 0.005 |
| Silicon | 0.15 | 0.7 | 0.2 | 0.35 |
| Vanadium | 0.02 | 0.1 | 0.02 | 0.03 |
| Niobium | — | 0.1 | — | — |
| Hydrogen | — | 2 ppm | — | — |
| Nickel | — | 0.3 | 0.1 | 0.25 |
| Chromium | — | 0.2 | 0.8 | 1.1 |
| Molybdenum | — | 0.15 | 0.15 | 0.25 |
| Copper | — | 0.25 | — | 0.25 |
| Lead | — | — | — | 0.002 |
| Titanium | — | — | — | 0.03 |
| Aluminum | 0.01 | 0.02 | 0.015 | 0.055 |

TABLE 2
Mechanical Properties for Lightweight Axles
Mechanical Properties

| | Amsted Rail-Grade 1 | Amsted Rail-Grade 2 |
|---|---|---|
| | Min-max | Min |
| Ultimate Tensile Strength (ksi) | 136 | 152 |
| Yield Strength (ksi) | 96 | 132 |
| Elongation (%) | 16 | 16 |
| Reduction of Area (%) | 35 | 42 |
| Grain Size (ASTM E112) | 6-9 | 6-9 |
| Rockwell C Hardness (Rc) | — | 30 |
| Rotating Beam Test Sample | 68 | 76 |
| Endurance Limit Se′ (ksi) | | |

One example of an improved railway car axle can be utilized in AAR approved railway car trucks for service with railway freight cars designed for up to about 286000 lbs. or more of gross weight freight car service. The railway car axle is a generally cylindrical, elongated seamless hollow tube structure comprised of selected alloys. Such seamless tube is typically formed into the near net shape in a forging operation, and then machined to final desired outer dimensions. Selected internal dimensions of the finished tube to form the axle are a result of the initial dimensions of the seamless tube before the forging operation and then a result of the actual forging operation to assure that the finished axle meets the desired strength and other performance related specifications.

In some examples, the railway car axle includes a first journal near a first end of the axle. The journal is generally cylindrical and is utilized for mounting a first bearing assembly thereon. A second journal is provided at the other end of the railway car axle and is designed for mounting a second bearing assembly thereon.

A first dust guard seat is adjacent the first journal on the railway car axle. The first dust guard seat is of a generally cylindrical configuration and is of a generally larger diameter than the first journal. A second dust guard is provided adjacent the second journal with dimensions and properties similar to the first dust guard seat.

A first wheel seat is provided adjacent the first dust guard seat. The first wheel seat is also generally cylindrical in structure and of a diameter larger than the first dust guard. A second wheel seat is provided adjacent the second dust guard seat, and is also of a generally cylindrical structure of a diameter greater than the second dust guard seat.

The portion of the axle extending between the first wheel seat and the second wheel seat is generally cylindrical and has a selected diameter at midpoint to provide the heavy haul performance characteristics.

This application describes axle designs designed to reduce the weight of an axle, thereby increasing the mass rate at which products can be transported without the need to increase the speed of the railcar. Reducing the weight of a railway axle remains a goal to allow increased lading for a railway freight car without increasing the gross weight of the railway freight car. However, lightweight axles have experienced fatigue failure in revenue service at a time when fatigue failure was not widely understood. Such fatigue failures have been studied giving way to historical knowledge including a greater understanding of the causes of fatigue failure as well as methods to analyze and improve the fatigue strength of materials and, therefore, the endurance limits of axles. The improved axle designs presented herein are based on advanced analytical techniques used to examine the residual stresses induced in lightweight axles during wheel mounting in addition to realistic loading conditions experienced in revenue railway freight car service to determine the endurance limit necessary to manufacture a lightweight axle that meets heavy haul freight car service requirements. In addition, the manufacturing processes proposed help achieve endurance limits required for acceptable fatigue life of railway freight car axles used in heavy haul service.

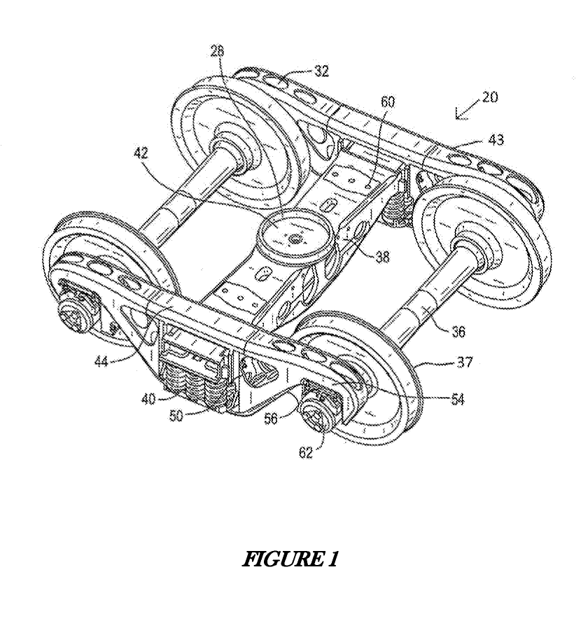

Referring now to the Figures, FIG. 1 shows a typical railway freight car truck 20. Railway freight car truck 20 is seen to be comprised of two laterally spaced side frames 43 and 44. Each side frame is a unitary cast steel structure. Bolster 38 extends laterally and transverse to side frames 43 and 44 and is supported thereon in bolster openings 50 on spring groups 40. Bolster 38 is also a unitary cast steel structure. The top structure of bolster 38 includes side bearing supports 60 which are laterally spaced and a center plate structure 28. The freight car itself would be supported on side bearings (not shown) on side bearing supports 60 and a center plate 42 within center plate structure 28.

Axles 36 extend laterally between side frame pedestals 54 located at either end of side frame 44. The ends of axles 36 are seen to extend into bearings 62 with bearing adapters 56 which are received in the pedestal jaw openings formed by the pedestal end 54 of side frame 44. Wheels 37 are press fit onto the wheel seat portion of axles 36 and are laterally spaced from each other by a distance that corresponds to the gage spacing of the railway tracks. Wheels are usually unitary cast or forged steel structures.

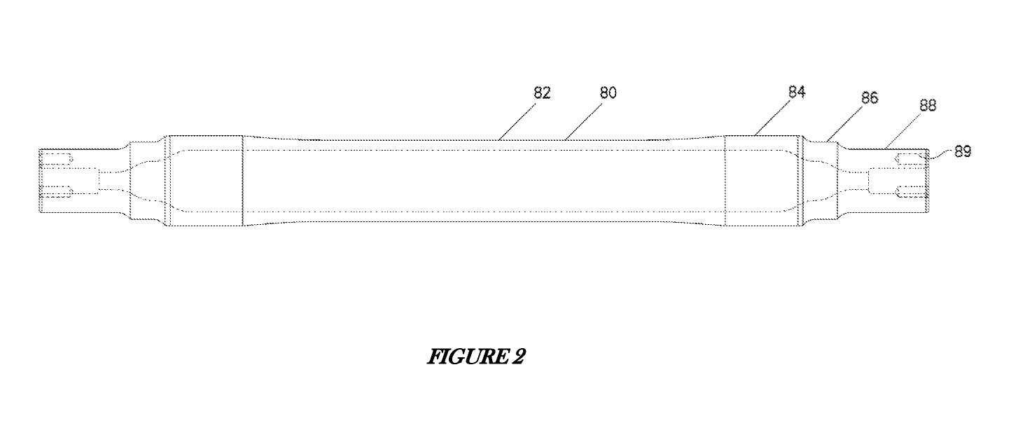

FIGS. 2 through 7 depict examples of axles that are configured to work in connection with the freight car truck 20 of FIG. 1. That is, the depicted axles have the same external dimensions in order to maintain the form, fit, and function of standard railway axles. However, as will be appreciated, the depicted axles offer significant improvements over the existing axles, for example, in the way of reduced weight and material.

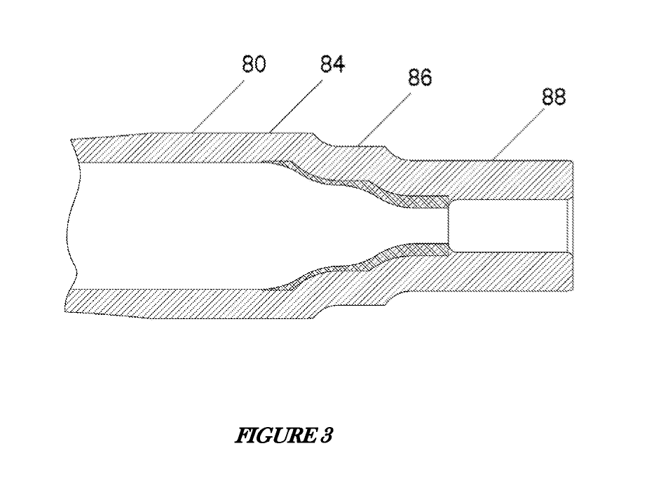

FIGS. 2 and 3 show an example of such a railway car axle 80, and a close up of the journal section 88, respectively, in detail. Railway car axle 80 is seen to comprise a generally cylindrical elongated structure. While the Figures do not depict dimensions or tolerances, it should be appreciated that the axle shown in FIG. 2 may have a length of about 87.156+/−0.062 inches, and be comprised of a carbon steel that is forged to near net shape and then the outer surface is machined to final shape.

Railway car axle 80 is seen to comprise bearing journals 88 at either end. Journals 88 may be of a reduced diameter, for example, of about 6.1905 to about 6.1915 inches to accept an axle bearing thereon. Axle bearing is usually held on by three bolts which extend into openings 89 in the ends of railway car axle 80.

Laterally inward from journal 88 of railway car axle 80 is dust guard seat 86. Dust guard seat 86 may have a diameter of about 7.530 to about 7.532 inches, which is slightly greater than that of journal 88, and extends from journal 88 by a radius structure in railway car axle 80.

Further inward from dust guard seat 86 is wheel seat 84. Wheel seat 84 can have diameter, for example, of about 8.735 to about 8.890 inches, which is larger than dust guard seat 86, and extends from dust guard seat 86 by a radius structure.

The center portion 82 of railway car axle 80 can vary in diameter depending on the material used to form the center portion 82. For example, the center portion 82 may have a diameter of about 8.26 inches or more when the center portion is made from Amsted Rail Grade 1 steel as depicted in Tables 1 and 2. Alternatively, center portion may have a diameter of about 7.95 inches or more when made from Amsted Rail Grade 2 as depicted in Tables 1 and 2. Both of these diameters are reduced from the diameter of the wheel seat 84. The inner opening diameter of the central portion can be about 6+/−0.0625 inches for both material grades yielding thicknesses of about 1.09 inches or more when made from Amsted Rail Grade 1 and about 0.94 inches or more when made from Amsted Rail Grade 2.

The outer diameter of wheel seat 84 can be about 8.735 to about 8.890 inches, with an inner opening diameter of about 6+/−0.0625 inches. The thickness of the wheel seat portion 84 can be about 1.33 inches or more when made from Amsted Rail Grade 1 and about 1.30 inches or more when made from Amsted Rail Grade 2. The length of each wheel seat can be about 7.625 inches.

The outer diameter of dust guard seat portion 86 can be about 7.530 to about 7.532 inches, with an inner opening diameter of about 3.8 inches or less when made from Amsted Rail Grade 1 and about 4.28 inches or less when made from Amsted Rail Grade 2. These openings yield wall thicknesses of about 1.86 inches or more and about 1.625 inches or more for Amsted Rail Grade 1 and Amsted Rail Grade 2; respectively. The length of each dust guard seat 86 can be about 3.40 inches.

The outer diameter of journal portion 88 can be about 6.1905 to about 6.1915 inches, with an inner opening diameter of about 2.5 inches. Wall thicknesses of journal 88 are about 1.84 inches or more when manufactured from Amsted Rail Grade 1 or about 1.625 inches or more when manufactured from Amsted Rail Grade 2; however, for both materials, the prevailing bore through the journal has a nominal diameter of about 2.5 inches. The length of each journal 88, including the radius leading to the dust guard seat, is about 8.931 inches.

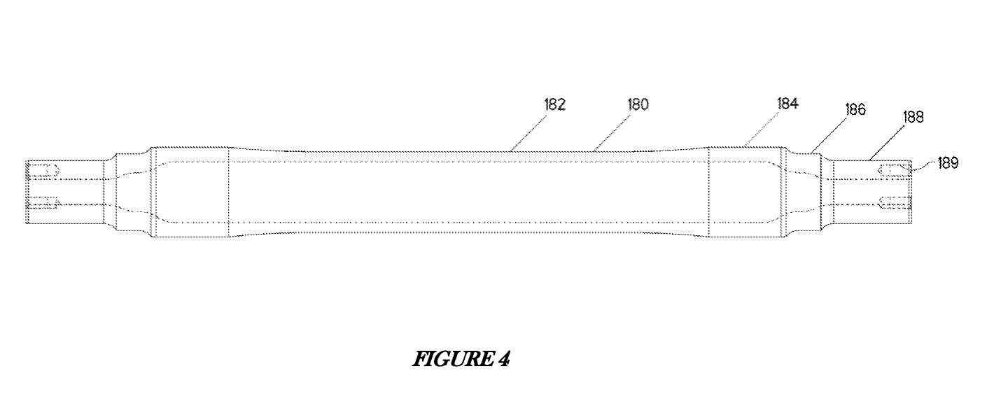

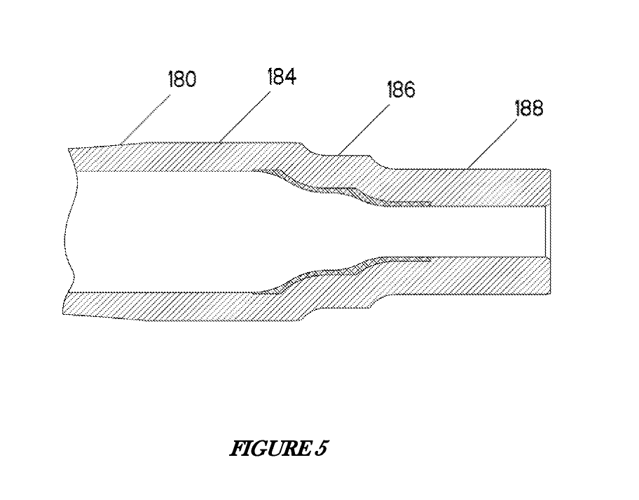

Referring now to FIGS. 4 and 5, another example of a railway car axle 180, and a journal portion 188, respectively, is shown in detail. Railway car axle 180 is seen to comprise a generally cylindrical elongated structure, and can have a length of about 87.156+/−0.062 inches. The axle 180 can be comprised of a carbon steel that is forged to near net shape and then the outer surface is machined to final shape.

Railway car axle 180 is seen to comprise bearing journals 188 at either end. Journals 188 may have a reduced diameter of about 6.1905 to about 6.1915 inches to accept an axle bearing thereon. An axle bearing can be held on by three bolts which extend into openings 189 in the ends of railway car axle 180.

Laterally inward from journal 188 of railway car axle 180 is dust guard seat 186. In the depicted example, dust guard seat 186 may have a diameter of about 7.530 to about 7.532 inches, which is slightly greater than that of journal 188, and extends from journal 188 by a radius structure in railway car axle 180.

Further inward from dust guard seat 186 is wheel seat 184. Wheel seat 184 may have a diameter of about 8.735 to about 8.890 inches, which is larger than dust guard seat 186, and extends from dust guard seat 186 by a radius structure.

In some embodiments, for instance, where the axle is formed from Amsted Rail Grade 1 material, the center portion 182 of railway car axle 180 can have a diameter of about 8.26 inches or more. In other embodiments, for instance, where the axle is formed from Amsted Rail Grade 2 material, the center portion 182 may have a diameter of about 7.95 inches or more. In either case, the center portion 182 is of a reduced diameter from wheel seat 184.

The inner opening diameter of about 6+/−0.0625 inches is standard for both material grades yielding thicknesses of about 1.09 inches or more when made from Amsted Rail Grade 1 and about 0.94 inches or more when made from Amsted Rail Grade 2.

The outer diameter of wheel seat 184 is 8.735 to 8.890 inches, with an inner opening diameter of about 6+/−0.0625 inches and wall thickness of about 1.33 inches or more when made from Amsted Rail Grade 1 and about 1.30 inches or more when made from Amsted Rail Grade 2. The length of each wheel seat is about 7.625 inches.

The outer diameter of dust guard seat 186 can be about 7.530 to about 7.532 inches, with an inner opening diameter of about 3.8 inches or less when made from Amsted Rail Grade 1 and about 4.28 inches or less when made from Amsted Rail Grade 2 yielding wall thicknesses of about 1.86 inches or more and about 1.625 inches or more, respectively. The length of each dust guard seat 186 is about 3.40 inches.

The outer diameter of journal 188 can be about 6.1905 to 6.1915 inches, with an inner opening diameter of about 2.5 inches. Wall thicknesses of journal 188 are about 1.84 inches or more when manufactured from Amsted Rail Grade 1 and about 1.625 inches or more when manufactured from Amsted Rail Grade 2; however, for both materials, the prevailing bore through the journal will have a nominal diameter of 2.5 inches. The length of each journal 188, including the radius leading to the dust guard, is about 8.931 inches.

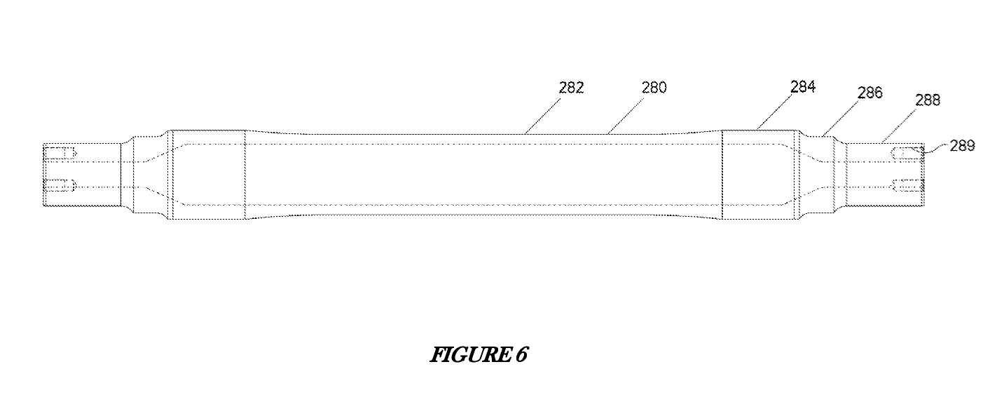

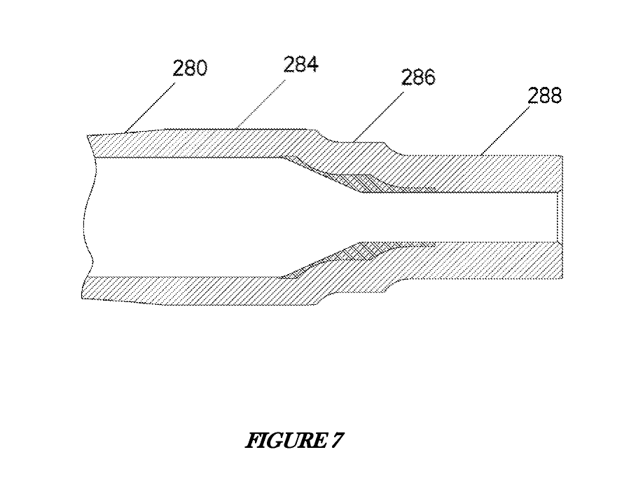

Referring now to FIGS. 6 and 7, another example of a railway car axle 280, and a journal portion 288, respectively, is shown in detail. Railway car axle 280 comprises a generally cylindrical elongated structure of a length of about 87.156+/−0.062 inches, and may be formed of a carbon steel that is forged to near net shape and then the outer surface is machined to final shape.

Railway car axle 280 to comprise bearing journals 288 at either end. Journals 288 are seen to be of a reduced diameter of 6.1905 to 6.1915 inches to accept an axle bearing thereon. Axle bearing can be held on by three bolts which extend into openings 289 in the ends of railway car axle 280.

Laterally inward from journal 288 of railway car axle 280 is dust guard seat 286. Dust guard seat 286 can have a diameter of about 7.530 to about 7.532 inches, which is slightly greater than that of journal 288, and extends from journal 288 by a radius structure in railway car axle 280.

Further inward from dust guard seat 286 is wheel seat 284. Wheel seat 284 may have a diameter of about 8.735 to about 8.890 inches which is larger than dust guard seat 286, and extends from dust guard seat 286 by a radius structure. Center section 282 of railway car axle 280 can have a diameter of about 8.26 inches or more when made from Amsted Rail Grade 1 and about 7.95 inches or more when made from Amsted Rail Grade 2. In either situation, the diameter of the center section 282 is reduced from that of the wheel seat 284.

The outer diameter of railway car axle 280 at center section 282 is about 8.26 inches or more when made from Amsted Rail Grade 1 and about 7.95 inches or more when made from Amsted Rail Grade 2. The inner opening diameter of about 6+/−0.0625 inches is standard for both material grades yielding thicknesses of about 1.09 inches or more when made from Amsted Rail Grade 1 and about 0.94 inches or more when made from Amsted Rail Grade 2.

The outer diameter of wheel seat 284 can be about 8.735 to about 8.890 inches, with an inner opening diameter of about 6+/−0.0625 inches and thickness of about 1.33 inches or more when made from Amsted Rail Grade 1 and about 1.30 inches or more when made from Amsted Rail Grade 2. The length of each wheel seat can be about 7.625 inches.

The outer diameter of dust guard seat 286 can be about 7.530 to about 7.532 inches, with an inner opening diameter of about 2.5 inches when made from Amsted Rail Grade 1 material or about 4.28 inches or less when made from Amsted Rail Grade 2 material, yielding wall thicknesses of about 2.52 inches or more and about 1.625 inches or more, respectively. The length of each dust guard seat 286 can be about 3.40 inches.

The outer diameter of journal 288 can be about 6.1905 to 6.1915 inches, with an inner opening diameter of about 2.5 inches. Wall thicknesses of journal 288 are about 1.84 inches when manufactured from Amsted Rail Grade 1 material and about 1.625 inches or more when manufactured from Amsted Rail Grade 2 material. However, in either case, the prevailing bore through the journal will have a nominal diameter of about 2.5 inches. The length of each journal 288 can be about 8.931 inches.

The dimensions mentioned above are preferred dimensions for a railway car axle in accordance with certain embodiments that would provide service in so called heavy haul conditions, which would typically comprise a gross railway freight car weight of up to 286000 lbs. or more. It should be understood that, in describing the examples of the railway car axles above, that each such axle in operation would include or operate in connection with two laterally spaced wheel seats 84, two laterally spaced dust guard seats 86, and two laterally spaced journals 88.

In the manufacture of the described railway freight car axles, a hollow cylindrical tube of the alloy composition of Error! Reference source not found., or Table 2: Mechanical Properties for Lightweight Axles is selected. Such tube is typically of a length of about 80 to about 95 inches and a thickness of 1.5 to 2.5 inches. The tube is heated to about 2100° F. as part of a forging operation, and then is subjected to the actual forging operation. In the forging operation, the outer surface of the tube is contacted by forging hammers that reduce the diameter of certain sections of the tube, and form the tube into a near net shape wherein the tube now has a center axle portion, with each end having a wheel seat section, a dust guard seat section and a journal section.

The near net shape axle is subjected to a heat treat process where it is normalized, quenched and tempered at the appropriate temperatures and times to produce the mechanical properties shown in Table 2. During the heat treat process, the axle may or may not be subjected to a nitriding process such as, but not limited to gas nitriding or plasma nitriding to further increase the fatigue strength and therefore the endurance limits of the axle.

The near net shape axle is cut to length, the ends of the axle are finished and the axle journal is bored. Axle internal surfaces are subjected to manufacturing processes that either produce residual compressive stresses on the surfaces, harden the surfaces, or smooth the surfaces to increase the fatigue strength and, therefore, the endurance limit of the axle. These manufacturing processes may include machining, polishing, peening, shot peening, laser peening, burnishing, low plasticity burnishing, rolling, burnishing, roller burnishing, honing, grinding, wire brushing, or other processes to increase fatigue strength and, therefore, the endurance limit of the axle.

The outer surface of the tube is then finish machined to provide the final outer diameters of the axle center section, wheel seat section, dust guard seat section and journal section. The finished axle surfaces may be subjected to burnishing, low plasticity burnishing, rolling, burnishing, roller burnishing, rolling, or other processes that harden, produce residual compressive stresses, or improve the fatigue strength and, therefore, the endurance limit of the axle. The finished axle may have non-destructive testing performed, such as but not limited to ultrasound or ultrasonic testing, from either inner or outer surfaces of the axle to identify wall thicknesses, transverse cracks, longitudinal cracks, discontinuities, or other defects that impact fatigue endurance limits. The inner surface of the hollow axle may or may not be machined, with the initial selection of the tube with specified length and diameter and the design and control of the forging operation will result in the final axle having the specified thicknesses in the center section, the wheel seat section, the dust guard seat section and the journal section.

This application describes examples that are meant to be illustrative and not limiting. The various described examples could be modified and/or combined with one another without departing from the scope described herein. Further, features of one embodiment or example may be combined with features of other embodiments or examples to provide still further embodiments or examples as appropriate. All references that this application cites, discusses, identifies, or refers to are hereby incorporated by reference in their entirety.

1. A railway car axle forming an elongated cylindrical body, the axle comprising:
a central section; and
a pair of journal sections positioned on opposite sides of the central section;
wherein the elongated cylindrical body comprises a material having a minimum ultimate tensile strength of about 136 ksi, a minimum yield strength of about 96 ksi, a minimum elongation of about 16 percent, a minimum reduction of area of about 35 percent, a grain size of about 6-9 per ASTM E112, and a minimum rotating beam test sample endurance limit (Se′) of about 68 ksi.

2. The railway car axle of claim 1, wherein the axle comprises a hollow interior portion.

3. The railway car axle of claim 2, wherein the axle comprises a forged, seamless tube.

4. The railway car axle of claim 2, wherein the axle comprises an alloy, the alloy comprising primarily iron and about 0.43-0.75 percent by weight carbon, about 0.6-2.2 percent by weight manganese, about 0.0-0.045 percent by weight phosphorus, about 0.01-0.03 percent by weight sulfur, about 0.15-0.7 percent by weight silicon, about 0.02-0.1 percent by weight vanadium, about 0.0-0.1 percent by weight niobium, about 0.0-2 ppm hydrogen, about 0.0-0.3 percent by weight nickel, about 0.0-0.2 percent by weight chromium, about 0.0-0.15 percent by weight molybdenum, about 0.0-0.25 percent by weight copper, and about 0.01-0.02 percent by weight aluminum.

5. The railway car axle of claim 2, wherein the axle further includes two wheel seat sections, each wheel seat section positioned between each of the journal sections and the central section adjacent the central section, and two dust guard sections, each dust guard section positioned between a wheel seat section and a journal section.

6. The railway car axle of claim 5, wherein the center section has a minimum wall thickness of about 1.09 inches, wherein the wheel seat sections have a minimum wall thickness of about 1.33 inches, the dust guard sections have a minimum wall thickness of about 1.86 inches, and the journal sections have a minimum wall thickness of about 1.84 inches.

7. The railway car axle of claim 6, wherein the hollow interior portion has a diameter of at least about 6 inches in at least one location within the central section, wherein the hollow interior portion has a diameter of at least about 6 inches in at least one location within each wheel seat section, wherein the hollow interior portion has a diameter of at least about 3.8 inches in at least one location within each dust guard section, and wherein the hollow interior portion has a diameter of at least about 2.5 inches in at least one location within the each journal section.

8. The railway car axle of claim 2, wherein the hollow interior portion comprises a journal bore, wherein the nominal diameter of the journal bore maintains a cross section large enough to limit journal deflection due to shear and bending to provide an acceptable level of fatigue due to frettage corrosion and yield an acceptable fretting index.

9. The railway car axle of claim 8, wherein the tolerance position of the axle journal bore maintains sufficient threaded hole wall thickness to achieve full thread strength for securing bearing houses to axle journals thereby minimizing the probability for bearings to loosen during service.

10. A method of forming a railway car truck axle comprising:
selecting a hollow cylindrical tube having a length of about 80 to about 95 inches and a thickness of about 1.5 to about 2.5 inches;
forging the hollow cylindrical tube into a seamless tube having a central section, two wheel set sections adjacent each end of the central section, two dust guard sections adjacent each wheel set section, and two journal sections adjacent each dust guard section, the forging including:
heating the tube to about 2100° F.;
reducing the outer diameter of the tube with forging hammers to form a near net shape of the central section, wheel set sections, dust guard sections, and journal sections;
heat treating the forged hollow cylindrical tube,
cutting the heat treated tube to a desired length, and
boring the journal sections;
wherein the selected hollow cylindrical tube comprises an alloy, the alloy comprising primarily iron and about 0.43-0.75 percent by weight carbon, about 0.6-2.2 percent by weight manganese, about 0.0-0.045 percent by weight phosphorus, about 0.01-0.03 percent by weight sulfur, about 0.15-0.7 percent by weight silicon, about 0.02-0.1 percent by weight vanadium, about 0.0-0.1 percent by weight niobium, about 0.0-2 ppm hydrogen, about 0.0-0.3 percent by weight nickel, about 0.0-0.2 percent by weight chromium, about 0.0-0.15 percent by weight molybdenum, about 0.0-0.25 percent by weight copper, and about 0.01-0.02 percent by weight aluminum.

11. The method of claim 10, wherein the axle has a minimum ultimate tensile strength of about 136 ksi, a minimum yield strength of about 96 ksi, a minimum elongation of about 16 percent, a minimum reduction of area of about 35 percent, a grain size of about 6-9 per ASTM E112, and a minimum rotating beam test sample endurance limit (Se′) of about 68 ksi.

12. The method of claim 11, wherein the axle is formed so that the center section has a minimum wall thickness of about 1.09 inches, the wheel seat sections have a minimum wall thickness of about 1.33, the dust guard sections have a minimum wall thickness of about 1.86 inches, and the journal sections have a minimum wall thickness of about 1.84 inches.

13. The method of claim 12, wherein the axle comprises a hollow interior portion with a diameter of at least about 6 inches in at least one location within the central section, wherein the hollow interior portion has a diameter of at least about 6 inches in at least one location within each wheel seat section, wherein the hollow interior portion has a diameter of at least about 3.8 inches in at least one location within each dust guard section, and wherein the hollow interior portion has a diameter of at least about 2.5 inches in at least one location within the each journal section.

14. A railway car axle forming an elongated cylindrical body, the axle comprising:
a central section; and
a pair of journal sections positioned on opposite sides of the central section;
wherein the elongated cylindrical body comprises a material having a minimum ultimate tensile strength of 152 ksi, a minimum yield strength of 132 ksi, a minimum elongation of 16 percent, a minimum reduction of area of 42 percent, a grain size of about to 6-9 per ASTM E112, a minimum Rockwell C hardness of Rc 30, and a minimum rotating beam test sample endurance limit (Se′) of about 76 ksi.

15. The railway car axle of claim 14, wherein the axle comprises a hollow interior portion.

16. The railway car axle of claim 15, wherein the axle comprises a forged, seamless tube.

17. The railway car axle of claim 15, wherein the axle comprises an alloy, the alloy comprises primarily iron and about 0.38-0.43 percent by weight carbon, about 0.75-1.0 percent by weight manganese, about 0.0-0.015 percent by weight phosphorus, about 0.0-0.005 percent by weight sulfur, about 0.2-0.35 percent by weight silicon, about 0.02-0.03 percent by weight vanadium, about 0.1-0.25 percent by weight nickel, about 0.8-1.1 percent by weight chromium, about 0.15-0.25 percent by weight molybdenum, about 0.0-0.25 percent by weight copper, about 0.0-0.002 percent by weight lead, about 0.0-0.03 percent by weight titanium, and about 0.015-0.055 percent by weight aluminum.

18. The railway car axle of claim 15, wherein the axle further includes two wheel seat sections, each wheel seat section positioned between each of the journal sections and the central section adjacent the central section, and two dust guard sections, each dust guard section positioned between a wheel seat section and a journal section.

19. The railway car axle of claim 18, wherein the center section has a minimum wall thickness of about 0.94 inches, wherein the wheel seat sections have a minimum wall thickness of about 1.30 inches, the dust guard sections have a minimum wall thickness of about 1.625 inches, and the journal sections have a minimum wall thickness of about 1.625 inches.

20. The railway car axle of claim 19, wherein the hollow interior portion has a diameter of at least about 6 inches in at least one location within the central section, wherein the hollow interior portion has a diameter of at least about 6 inches in at least one location within each wheel seat section, wherein the hollow interior portion has a diameter of at least about 3.8 inches in at least one location within each dust guard section, and wherein the hollow interior portion has a diameter of at least about 2.5 inches in at least one location within the each journal section.

21. The railway car axle of claim 15, wherein the hollow interior portion comprises a journal bore, wherein the nominal diameter of the journal bore maintains a cross section large enough to limit journal deflection due to shear and bending to provide an acceptable level of fatigue due to frettage corrosion and yield an acceptable fretting index.

22. The railway car axle of claim 21, wherein the tolerance position of the axle journal bore maintains sufficient threaded hole wall thickness to achieve full thread strength for securing bearing houses to axle journals thereby minimizing the probability for bearings to loosen during service.
